(19) United States
(12) Patent Application Publication
(10) Pub. No.: US 2009/0150632 A1
(43) Pub. Date: Jun. 11, 2009

(54) Directory and Methods of Use

(75) Inventors: Richard H. Harvey, Victoria (AU); Ronald W. Ramsay, Victoria (AU)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/331,616

(22) Filed: Dec. 10, 2008

Related U.S. Application Data
(60) Provisional application No. 61/012,689, filed on Dec. 10, 2007.

(51) Int. Cl. G06F 12/14; G06F 12/00

(52) U.S. Cl. 711/164; 711/170; 711/E12.001; 711/E12.084

(57) ABSTRACT

A method of arranging data in a directory, the directory being adapted to interface with disk storage, the method includes arranging data of a directory in a format that is configured to enable the directory data to be mapped by an operating system. The data of the directory is stored in computer-readable storage. The method also includes associating a first portion of a non-persistent computer-readable memory with the data of the directory at least in part by calling a memory map function of the operating system. The memory map function returning a pointer corresponding to the first portion of the non-persistent computer-readable memory. The method further includes synchronizing the associated first portion of the non-persistent computer-readable memory with the data of the directory stored in the computer-readable storage.

### RELATED APPLICATION

This application claims benefit under 35 U.S.C. § 119(e) of U.S. Provisional Application Ser. No. 61/012,689, entitled “A DIRECTORY AND METHODS OF USE,” filed Dec. 10, 2007, by Richard H. Harvey et al.

### TECHNICAL FIELD

This disclosure relates in general to the field of directory systems and/or services, and more particularly to a method, system, and apparatus for performing directory operations.

### BACKGROUND

In conventional directory systems, one way of representing computer-readable data is in a hierarchical tree-like structure of a directory-based system, commonly referred to as a Directory Information Tree (DIT). Various directory services include software that stores, organizes and provides access to information in a directory. Some conventional directory systems and services are limited for a variety of reasons. For example, some applications delegate data management to external data management systems that are complex, costly, and difficult to maintain. Some conventional systems operate on the principle of partial loading, meaning not all of the data is loaded because more data can be retrieved from a disk when further data is required. But this principle may limit the performance of some applications. Indexes are typically stored on and retrieved from secondary storage. In the case of read performance, some systems have increased memory usage to achieve performance through caching, but to cache large data sets often requires large amounts of memory, which is costly and limits performance across a full data set.

### SUMMARY

In a method embodiment, a method of arranging data in a directory, the directory being adapted to interface with disk storage, the method comprises arranging data of a directory in a format that is configured to enable the directory data to be mapped by an operating system. The data of the directory is stored in computer-readable storage. The method also comprises associating a first portion of a non-persistent computer-readable memory with the data of the directory at least in part by calling a memory map function of the operating system. The memory map function returning a pointer corresponding to the first portion of the non-persistent computer-readable memory. The method further comprises synchronizing the associated first portion of the non-persistent computer-readable memory with the data of the directory stored in the computer-readable storage.

Numerous technical advantages are provided according to various embodiments of the present disclosure. Particular embodiments of the disclosure may exhibit none, some, or all of the following advantages depending on the implementation. For example, in some embodiments, significant speed advantages to the operation of a directory can be realized by leveraging the memory mapped functionality of the operating system to synchronize data in memory with a file on disk. Various embodiments may increase the efficiency of memory usage. Some embodiments may use a memory-mapped input/output (I/O) that may significantly increase the processing speed of some directory operations. In some cases, for example, use of a memory-mapped I/O to process some directory operations may be up to 100 times faster than some conventional directory operation processes. In various embodiments, read performance may be achieved for the entire data set, which is an improvement over some conventional systems that achieve read performance only for a subset of data that is cached. Write performance may be achieved, in some embodiments, utilizing the speed of the memory-mapped I/O function of the operating system. In some embodiments, the operating system independently handles I/O of a disk without a corresponding application having to do explicit reads or writes to the disk. In various embodiments, backup may be efficiently performed by writing memory to another file; and recovery may likewise be efficiently performed in some replicated environments by copying a file from a replicated system. In some embodiments, tuning may not be necessary in some cases where indexes are created on startup; clustering may not be necessary in some cases where all information is already in memory; and fragmentation may not be required. Processes associated with maintenance may be reduced in some embodiments that use only one main data file.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a block diagram illustrating one example of a portion of a system capable of performing directory operations;

FIG. 2 is one example embodiment of a flowchart illustrating example steps concerning synchronizing directory data with another memory, which may be used, for example, to perform directory operations by the system of FIG. 1; and

FIG. 3 is one example embodiment of a flowchart illustrating example steps of directory operations that may be used, for example, by the system of FIG. 1.

### DETAILED DESCRIPTION

The present disclosure relates generally to the field of directory information systems and/or services (e.g., The Domain Name System (DNS)), and more particularly to a method, system, and apparatus for performing directory operations. The present disclosure also relates to a method of arranging, storing, transfer and backup of data associated with a directory system and/or a directory service. In some embodiments, a directory system and/or service may enable the look up of a name and information associated with that name. Some such names may be associated with multiple, different pieces of information; and some such names may have many different types of data. Various directory systems and/or services may include software encoded in computer-readable medium that may be operable, when executed by one or more processors, to store, organize and/or provide access to information in a directory. Some embodiments may use standardized directory server technologies, such as, for example, Lightweight Directory Access Protocol (LDAP), X.500 and/or Directory Service Markup Language (DSML); however, any technology or standard, including future technologies or standards, may be used without departing from the scope of the present disclosure.

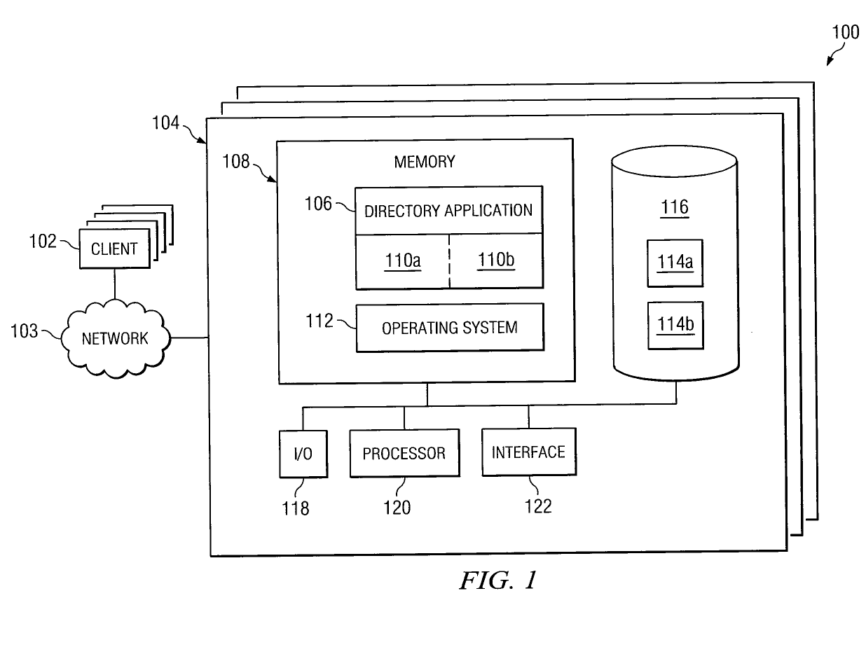

Particular embodiments of the present disclosure may include an application capable of storing data in memory that may be independently synchronized by the operating system with a file on disk. In this manner, the application does not necessarily need to explicitly read or write any data to or from the disk. Various embodiments may utilize the efficiency of the operating system to memory map files in a directory environment. For example, a file may be configured to contain data in a manner that enables the file to be memory mapped. In some embodiments, significant speed advantages to the operation of a directory can be realized by leveraging the memory mapped functionality of the operating system to synchronize data in memory with a file on disk. Furthermore, processing speed improvements can be achieved, in some embodiments, by arranging the data into a contiguous block of memory. The example embodiments of the present disclosure are best understood by referring to FIGS. 1 through 3 of the drawings, like numerals being used for like and corresponding parts of the various drawings.

FIG. 1 is a block diagram illustrating one example of a portion of a system 100 capable of performing directory operations. In this particular embodiment, the illustrated portion of system 100 generally includes one or more clients 102 coupled through a network 103 to one or more servers 104. As used throughout this document, the term “couple” and/or “coupled” refers to any direct or indirect communication between two or more elements, whether or not those elements are in physical contact with one another.

Each client 102 may comprise any computing and/or communication device capable of enabling the communication of information to and/or from network 103 or another component in system 100. Client 102 may comprise, for example, a wireless device, a voice over Internet protocol (IP) device, a desktop computer, a laptop computer, a personal digital assistant, a cell-phone, a telephone, a Wi-Fi device, a workstation, a mainframe computer, a mini-frame computer, a web server, or any other computing and/or communicating device. In some embodiments, client 102 may enable a user of system 100 to communicate information to and/or receive information from one or more servers 104. In other embodiments, clients 102 can enable a user of system 100 to communicate information to and/or receive information from one or more components of system 100. In some embodiments, the communication between a particular client 102 and one or more of the servers 104 may be performed internally, such as, for example, via a system bus, and/or the communication between a particular client 102 and one or more of the servers 104 may be through network 103. For example, clients 102 may each be capable of communicating one or more requests through network 103, which request(s) may be received and processed, for example, by server 104 using Directory Application 106.

Network 103 may comprise any wireless network, wireline network, or combination of wireless and wireline networks capable of supporting communication between network elements using ground-based and/or space-based components. In various embodiments, network 103 may be capable of transmitting audio, video, signals, data, messages, or any combination of these or other communication signals. For example, network 103 may comprise a data network, a public switched telephone network (PSTN), an integrated services digital network (ISDN), a local area network (LAN), a wide area network (WAN), a metropolitan area network (MAN), all or a portion of the global computer network known as the Internet, and/or other communication systems or combination of communication systems at one or more locations.

Servers 104 may include any hardware, software, firmware, or combination thereof capable performing at least a portion of a directory operation. In various embodiments, servers 104 may include, for example, one or more directory servers, client servers, file servers, domain name servers, proxy servers, web servers, application servers, computer workstations, handheld devices, databases, some other data repository, any combination of the preceding, or any other machine(s) or apparatus capable of performing all or a portion of a directory operation. Servers 104 may execute with any of the well-known MS-DOS, PC-DOS, OS-2, MAC-OS, WINDOWS™, UNIX, or other appropriate operating systems, including future operating systems.

In the illustrated embodiment, server 104 includes a memory 108, a Data storage 116, input/output functionality 118, one or more processors 120, an interface 122. Although server 104 includes a memory 108, a Data storage 116, input/output functionality 118, one or more processors 120, and an interface 122 in this example, one or more of memory 108, Data storage 116, input/output functionality 118, one or more processors 120, and an interface 122 can be excluded from server 104 without departing from the scope of the present disclosure.

Memory 108 may, for example, comprise a dynamic random access memory (DRAM), a static random access memory (SRAM), a NAND flash memory, or any other suitable volatile or nonvolatile storage and retrieval device or combination of devices. Memory 108 may comprise any number of storage media without departing from the scope of the present disclosure. Additionally, all or part of memory 108 could reside locally within server 104 or could reside in a location remote from and accessible to server 104. In this particular example, memory 108 includes one or more partitions 110.

In this example, at least respective portions of Directory Application 106, memory partition 110, and operating system 112 reside within memory 108 of server 104; however, all or a portion of Directory Application 106, memory partition 110, and/or operating system 112 may alternatively reside at any other suitable location, such as, for example, external to memory 108 and/or external to server 104; and Directory Application 106 may be embodied in any of a variety of other suitable computer-readable medium, such as, for example, removable media. Although FIG. 1 illustrates Directory Application 106 as external to operating system 112, all or a portion of Directory Application 106 may, for example, be stored within memory 108 as a portion of operating system 112 without departing from the scope of the present disclosure. Directory Application 106, memory partition 110, and/or operating system 112 may comprise, for example, software, firmware, code, portions of code, data compilations, and/or a combination of these or any other type of data.

Data storage 116 may refer, for example, to one or more databases, computer components, devices, and/or recording media capable of retaining digital data. Data storage 116 may, for example, comprise a magnetic data storage device (e.g., a diskette or a hard disk drive), an optical disc storage medium (e.g., a Laserdisc), a magneto-optical disc-based data storage device (e.g., a MiniDisc), a dynamic random access memory (DRAM), a static random access memory (SRAM), a NAND flash memory, or any other suitable volatile or nonvolatile storage and retrieval device or combination of devices. Data storage 116 may comprise any number of storage media without departing from the scope of the present disclosure. Additionally, all or part of data storage 116 could reside locally within server 104 or could reside in a location remote from and accessible to server 104 (e.g., at some other server 104, within removable media, and/or at an external database).

Input/output functionality 118 may refer, for example, to the communication between server 104 and one or more other devices (e.g., one or more of clients 102, a display, or another information processing system). Some inputs may refer to the signals or data received by server 104, and some outputs may refer to the signals or data communicated by server 104. These terms may also refer to part of an action. For example, to “perform I/O” may involve performing an input or output operation. In some cases, devices for communication between client(s) 102 and/or server(s) 104 may be used to implement both input and output functionality.

Interface 114 may comprise, for example, any device(s) that may be used (e.g., by a person, or by another device or system) to communicate with server 104. For example, keyboards and mice may be considered input interfaces of server 104, while monitors and printers may be considered output interfaces of server 104.

In some embodiments, some or all of the functionality and/or structure of one or more clients 102 and one or more servers 104 may be embodied in a single device, or in one or more other devices not illustrated in FIG. 1. In some such embodiments, the communication between one or more server 104 may be performed internally, such as, for example, via a system bus. In this example, servers 104 are all coupled to each other through network 103.

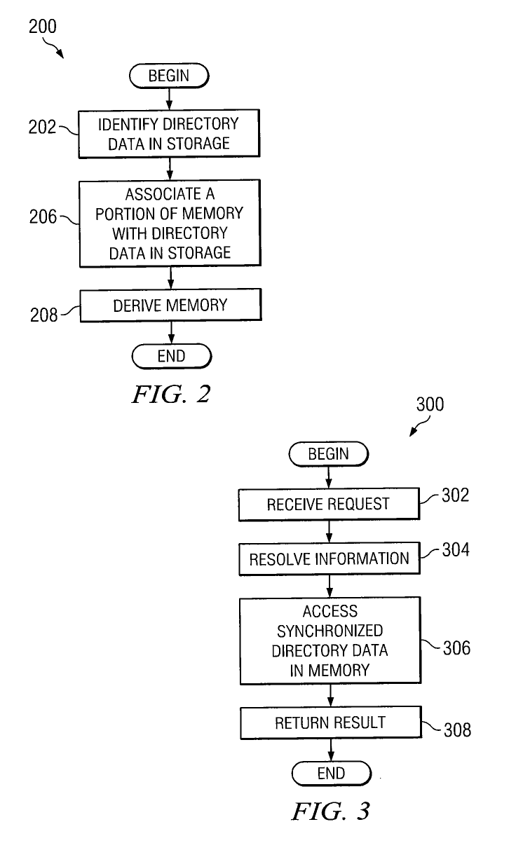

In this example, Directory Application 106 is generally operable, when executed by one or more processors 120, to perform one or more directory operations using memory partition 110. In this particular example, memory partition 110 comprises at least two memory parts 110a and 110b. Memory part 110a may be used, for example, to store information and indexes related to data; and memory part 110b may be used, for example, to store the data and associated identifiers. Although FIG. 1 illustrates memory parts 110a and 110b as stored in one continuous memory block 110 of memory 108, memory parts 110a and 110b may be stored in two non-continuous memory blocks without departing from the scope of the present disclosure. Additional detail regarding example operations that may be performed by system 100 using Directory Application 106 is described further below with reference to FIG. 2.

FIG. 2 is one example embodiment of a flowchart 200 illustrating example steps concerning synchronizing memory 108 with directory data 114 stored within data storage 116, which synchronization may be used, for example, to perform directory operations by the system 100 of FIG. 1. In this particular example, system 100 may use memory mapping capabilities of operating system 112 to synchronize a portion of memory 108 with directory data stored within data storage 116. In some embodiments, the synchronization may, for example, be configured to occur automatically, or may be in response to a startup sequence or a received request.

In this example, directory data is identified in step 202. For example, descriptors of one or more directory data file(s) 114 stored on data storage 116 may be retrieved using the open ( ) call of operating system 112. In this example, at least a portion of memory 108 is associated with the identified directory data in step 204. For example, Directory Application 106 may call a memory map function of operating system 112 using a mmap ( ) system call. Some such memory map functions may, for example, return a pointer to memory part 110b, which pointer may be used, for example, to synchronize memory part 110b with the one or more directory file(s) 114 opened in step 202. At least a portion of the information and/or indexes in memory part 110a may, for example, be derived in step 206 using the synchronized memory part 110b.

In some embodiments, at least some of the example steps 202 through 206 may be performed upon startup or in response to a received request; however, at least some of the example steps 202 through 206 may be performed independent of a startup sequence or received request. For example, at least some of the steps 202 through 206 may be configured to occur automatically, such as, for example, at periodic intervals or in response to detected changes within data storage 116 and/or memory 108. By synchronizing or otherwise associating a portion of memory 108 with directory data stored within data storage 116 in a manner substantially similar to that described above, the Directory Application 106 of various embodiments may work together with memory 108 and operating system 112 to perform directory operations. An example execution of a directory operation is described further below with reference to FIG. 3.

FIG. 3 is one example embodiment of a flowchart illustrating example steps concerning directory operations that may be used, for example, by the system 100 of FIG. 1. In this example, server 104 receives a request that involves one or more directory operations in step 302. The request may be received, for example, from one or more other servers 104 or from one or more clients 102. Directory Application 106 may resolve one or more parameters of the directory operation(s) associated with the request in step 304. For example, Directory Application 106 may determine that a particular directory operation further involves one or more pieces of directory data. The one or more pieces of directory data may include, for example, directory objects and/or their logical interrelations, which objects and/or interrelations may be stored, for example, in data storage 116 and synchronized in a portion 110b of memory 108. Directory Application accesses synchronized memory in step 306. For example, Directory Application 106 may access one or more pointers stored in memory 110a and/or 110b that correspond to the resolved parameter(s) of the directory operation(s). Directory Application 106 may use this information to efficiently access the corresponding piece(s) of synchronized directory data stored in memory 110b. Server 104 may return the result(s) in step 308. For example, server 104 may apply one or more of the results to a subsequent directory operation or may communicate the result(s) to one or more other servers 104 or to one or more clients 102 via network 103.

The example embodiments disclosed herein may include any of a variety of features and advantages. For example, in some embodiments, some or all of the directory operations performed by system 100 may be executed on a portion or portions of memory 108, which may have been previously synchronized to corresponding portions of data storage 116 using the input/output functions of operating system 112, thereby enhancing execution efficiency. That is, in various embodiments, Directory Application 106 may be capable of performing some or all directory operations using memory 108 without necessarily executing explicit fetch/store or read/write commands on data storage 116, thereby simplifying the complexity of some Directory Applications 106. In some embodiments, the amount of data stored within data storage 116 may be reduced. For example, the data stored within memory part 110a may consist substantially of indexes and/or associated identifiers; and the information and indexes associated with directory objects may be derived, for example, on startup and stored within memory 108, thereby freeing space within data storage 116. In addition, the synchronized data that may be stored in memory part 108 may be very compact.

Another advantage of some embodiments of the present disclosure relates to the speed of backup. Referring to FIG. 1, a backup of a file 114a may be performed, for example, by opening another file 114b stored within data storage 116 and writing to the backup file 114b the synchronized information within memory 110b that corresponds to file 114a. Performing backups in a manner substantially similar to the manner described above may include any of a variety of features and advantages. For example, the backup may be performed by a single write operation. In addition, the backup does not necessarily require the data to be initially read to a buffer before writing. In various embodiments, the data to be backed may be substantially written to just one file. It may be sufficient, in some embodiments, to back up only memory part 110b. For example, some embodiments may not necessarily need to back up both memory parts 110a and 110b if memory part 110a is derived at startup.

The synchronized memory 108 of various embodiments may comprise any of a variety of features, data file layouts, and relationships between data. For example, the directory data synchronized within memory 108 may be arranged in records. In some embodiments, each record may correspond to a memory-mapped file stored within memory 108; each record may contain one or more respective values; and/or each record may further contain an entry ID (EID) and an attribute type ID (AID). In some embodiments where values associated with an EID and an AID, changes can be made to entries, for example, without necessarily moving records. In some cases, an entry can be built, for example, by collecting all the records with the same EID; and values may, for example, be associated with the same attribute type based on the AID. In some embodiments, a special record may associate each EID with the EID of a parent entry. Object classes may be stored entirely or substantially in the AID, thereby enabling at least some of these records to have virtually zero data length.

According to various embodiments, additional features of the data file records and space management of memory 108 may include one or more of the following examples: records can be marked ‘empty’ and reused; records may be, for example, in multiples of two bytes to help memory management (as described further below); each record may comprise a size quantity to hold the size of the data value it contains; each record may comprise a special ‘pad’ character to bring the size of a record up to the next multiple of two or more bytes; free lists may be maintained in-memory to locate empty records in the file; and multiple free lists may address records in multiples of two bytes.

According to a particular embodiment, an example data file format may be configured as follows. Every record in memory 108 may, for example, be preceded by the EID and AID; which may be followed, for example, by the size of the value and the Abstract Syntax Notation One (ASN.1) encoding of the value (with the exception of special cases). The EID may, for example, be a four-byte quantity, which may allow at least four billion entries in this example. In some cases, special flags may use the first three bits, which may limit the scope to 500 million entries in this example. The AID may be a two-byte quantity, which may allow 65000 attributes in this example. Due to the special treatment of object class, the actual limit may be 32767 in this example. The value size (SIZE) may be a four-byte quantity, allowing 4-billion-byte values (theoretically) in this example. The size field may be used to store the parent EID when the AID is 0. The format of records in the data file may comprise a 10-byte header, a variable length value, and padding bytes. The unused remainder of the file will be filled with OxFF. Therefore, one example of the data file format may be represented as follows:

E E E E A A S S S S <Value> <P> E E E E A A S S S S
<Value> <P> ... <F>

where
E is a byte of an entry identifier,
A is a byte of an attribute identifier,
S is a byte of a size,
<Value> is the bytes of a value,
<P> is zero or more padding bytes to be used for word boundary alignment, and
<F> is zero or more fill bytes used to indicate unused space in the file.

One particular example of a top-level or parent entry may be as follows:

| | | |
|---|---|---|
| 00 00 00 01 | EID | |
| 00 00 | AID | Special Case: Size contains Parent EID |
| 00 00 00 00 | SIZE | Special Case: Parent EID of 00 00 00 00 |
| | | indicates that this is the root of the DIT |
| | | No value |
| FE FE | PADDING | Padding is external to entry |

One particular example specifying object class may be as follows:

| | | |
|---|---|---|
| 00 00 00 01 | EID | |
| 80 00 | AID | Special Case: High-bit set indicates |
| | | objectClass, remaining bits are an index |
| | | into the OC file |
| 00 00 00 00 | SIZE | |
| | | No Value |
| FE FE | PADDING | Padding is external to entry, not included in |
| | | SIZE |

One particular example of a deleted record may be as follows:

| | | |
|---|---|---|
| 80 00 00 01 | EID | Special Case: EID with first bit set denotes |
| | | empty/deleted record |
| 00 04 | AID | Irrelevant in deleted record |
| 00 00 00 08 | SIZE | Size of deleted value |
| 13 05 30 30 30 | VALUE | Irrelevant in deleted record |
| 30 30 | | |
| FE | PADDING | Included in size |

One particular example specifying relative distinguished names (RDN) at the end of a file may be as follows:

| | | |
|---|---|---|
| 40 00 00 01 | EID | Special Case: Bit 6 set denotes |
| | | Distinguished Value |
| 00 04 | AID | Index into ‘attribute’ file starting at 1 |
| | | (commonName in this example) |
| 00 00 00 07 | SIZE | |
| 13 05 30 30 30 | VALUE | ASN.1 formatted (protocol encoded) |
| 30 30 | | value: PrintableString/Length = |
| | | 5/ASCII “00000” |
| FE FE FE | PADDING | |
| FF FF FF FF FF | FILL | Fill remaining file size |
| FF FF | | |

To aid in space reuse, for example, the last byte of a value can be followed by pad bytes (OxFE) over multiple 2-byte boundaries.

Although example details of a data file format are described above, any of a variety of alternative data file formats may be used without departing from the scope of the present disclosure. Some alternative embodiments, for example, may use compressed values and attributes with variable-length encoding. Some such embodiments may, for example, use the top bit to indicate an overflow to the next byte, which may considerably reduce space. In accordance with one such alternative embodiment, records or entries may be encoded in a manner substantially similar to the following.

A ‘normal’ record may, for example, use the first 3 bits as 000 or 001 (distinguished) and the EID may, for example, take the remaining 5 bits and the next 3 bytes. The EID may, for example, be followed by a flag byte, the top bit of which may indicate whether the value identifier (VID) field is present and the remaining 7 bytes may, for example store an integer value representing the compression algorithm used to compress the value. The flag byte may, for example, be followed by the AID in expanding format (i.e., the high bit may indicate that the value continues into the next byte) followed optionally by a VID in expanding format. Various embodiments may not necessarily use a size field. The final part of the record, in this example, may be an ASN.1 value; and the size of the value can be determined by using ASN.1 rules. If the value is compressed, for example, the tag may be retained and the length may be changed to that of the compressed value. Therefore, one example of a data file format in accordance with this particular alternative embodiment may be represented as follows:

E E E E F A V <Value> <P> E E E E F A <Value> <P> ... <F>

where
E is a byte of an entry identifier, which may, for example, include four bytes if not a special record, as indicated by the first 3 bits not being 000;
F is a flag byte, the top bit of which may indicate ordering of values while the low order bits may contain a compression type;
A is a byte of an attribute identifier, which may take more than one byte while bytes have high-bit set;
V is a value identifier that may be encoded as a variable-length record if, for example, F has the high bit set (otherwise V may not occur);
<Value> is the bytes of a value,
<P> is zero or more padding bytes to be used for word boundary alignment (OxFE), and
<F> is zero or more fill bytes used to indicate unused space in the file (OxFF).

According to this particular embodiment, one example of a top-level or parent entry may be represented as follows:

| | | |
|---|---|---|
| C0 01 23 45 | EID | where 0x00012345 is the EID (CX XX XX XX and |
| | | DX XX XX XX may, for example, indicate ‘parent’ |
| | | record) |
| 81 8A 56 | PEID | Special Case: Parent EID 0x4556 (7-bits per byte) |

According to this particular embodiment, one example of a normal value record may be as follows:

| 00 01 EA 71 | EID | First three bits are clear |
|---|---|---|
| 00 | FLAG | May indicate, for example, whether values are |
| | | ordered and/or whether values are compressed. |
| | | For example, a FLAG set to ‘00’ may indicate |
| | | values are not ordered or compressed. |
| 04 | AID | Index into ‘attribute’ file starting at 0 |
| | | (commonName in this example) |
| 13 05 30 31 | VALUE | ASN.1 formatted (protocol encoded) value: |
| 32 33 34 | | PrintableString/Length = 5/ASCII “01234” |

According to this particular embodiment, one example of an ordered value record may be as follows:

| 00 01 EA 71 | EID | First three bits are clear |
|---|---|---|
| 80 | FLAG | A FLAG set to ‘80’ may, for example, indicate |
| | | values are not ordered and not compressed |
| 04 | AID | Index into ‘attribute’ file starting at 0 |
| | | (commonName in this example) |
| 03 | VID | A value used to sequence the values of this |
| | | attribute |
| 13 05 30 31 32 | VALUE | ASN.1 formatted (protocol encoded) value: |
| 33 34 | | PrintableString/Length = 5/ASCII “01234” |

According to this particular embodiment, one example of a naming value record may be as follows:

| 20 01 EA 71 | EID | Special Case: Bit 5 set denotes Distinguished |
|---|---|---|
| | | Value |
| 00 | FLAG | A FLAG set to ‘00’ may, for example, indicate |
| | | values are not ordered or compressed. |
| 04 | AID | Index into ‘attribute’ file starting at 0 |
| | | (commonName in this example) |
| 13 05 30 31 32 | VALUE | ASN.1 formatted (protocol encoded) value: |
| 33 34 | | PrintableString/Length = 5/ASCII “01234” |

According to this particular embodiment, one example of an object value class record may be as follows:

| A0 01 EA 71 | EID | First three bits are 101 |
|---|---|---|
| 03 | OC | An index into the OC file |

According to this particular embodiment, one example of a compressed value record may be as follows:

| 00 01 EA 71 | EID | First three bits are clear |
|---|---|---|
| 05 | FLAG | A FLAG set to ‘05’ may, for example, indicate |
| | | values are not ordered and compression code is 05 |
| 04 | AID | Index into ‘attribute’ file starting at 0 |
| | | (commonName in this example) |
| 13 05 f7 98 | VALUE | ASN.1 formatted (protocol encoded) value: |
| 09 55 45 | | PrintableString/Length = 5/bytes f7 98 09 55 |

According to this particular embodiment, one example of a deleted value record may be as follows:

| | | |
|---|---|---|
| FD | | Special Case: EID with first bits 111 indicates a |
| | | deleted record |
| 00 00 01 FE | SIZE | Size of the deleted record, including the previous |
| | | byte |

Thus, any of a variety of data file formats may be used without departing from the scope of the present disclosure, some of which may include variable-length encoding.

According to particular embodiments, indexing within a directory portion of system 100 may be effected using one or more of the following example features: in-memory structures may be created to reference the values in the file; the actual value may not be copied into another part of memory but rather may be referenced by its position in the file; and indexes may further be used to locate entries based on the values some of its attributes may contain.

According to particular embodiments, Distinguished Names (DN) and navigation associated with a directory portion of system 100 may include one or more of the following example features: in some cases, a DN of an entry may or may not be persistently stored; records containing distinguished attributes may be flagged; navigation may, for example, be performed RDN-by-RDN; navigation may involve disambiguating relative RDNs in different subtrees using the parent EID; and in some embodiments, if an RDN has no indexed values, a special RDN index may be used, for example, that only indexes RDNs containing contain no index values.

According to particular embodiments, searching within system 100 may include one or more of the following example features: searches specifying a base-object and no filter may be performed, for example, on entries that have respective child entries; space may be minimized, for example, by configuring system 100 such that each entry has only one child entry, but it also has a sibling entry; subordinate entries may be discovered, for example, by recursively following child EIDs and sibling EIDs; in some cases, whole-subtree searches from the root of the directory information tree (DIT) can be performed using indexed filter attributes; in some other cases whole-subtree searches can use the root entry identified by having ROOTEID as its EID; in some embodiments, if a search specifies both a filter and a base DN (which is not the root of the DIT), then a selection may be made of the most efficient method of locating the entries to be returned.

Some embodiments may include search optimizations in the form of search execution plans, which may include one or more of the following features: elements of the indexing system may contain counts of the entries they control; each entry may contain a count of all subordinate entries and a count of immediately subordinate entries; and some embodiments may compare an estimated count of candidate entries that would be returned by using the indexes in conjunction with the search filter with the count of entries in scope, thereby enabling a determination of the expected fastest method of assembling the search result.

In various embodiments, configuration files associated with the data file may include one or more of the following features: an attribute type file capable of mapping AIDs to LDAP names and other directory information associated with that attribute (e.g., an object identifier); and/or an object class file capable of mapping AIDs to LDAP names and other directory information associated with that object class (e.g., an object identifier).

Some embodiments may include a load utility capable of converting human readable LDAP Data Interchange Format (LDIF) text file of a directory information base into the binary data file and associated configuration files; and some such embodiments may include a dump utility capable of doing the reverse, namely converting the binary data file format to human readable LDIF text file.

It should be noted that where the terms “server,” “computer,” or similar terms are used herein, a communication device is described that may be used in a communication system and should not be construed to limit the present disclosure to any particular communication device type. Thus, a communication device may include, without limitation, a bridge, router, bridge-router (router), switch, node, or other communication device, which may or may not be secure.

It should also be noted that where a flowchart is used to demonstrate various aspects of the present disclosure, it should not be construed to limit the present disclosure to any particular logic flow or logic implementation. The described logic may be partitioned into different logic blocks (e.g., programs, modules, functions, or subroutines) without changing the overall results or otherwise departing from the true scope of the present disclosure. Often, logic elements may be added, modified, omitted, performed in a different order, or implemented using different logic constructs (e.g., logic gates, looping primitives, conditional logic, and other logic constructs) of the present disclosure.

Various embodiments may be embodied in many different forms, including computer program logic for use with a processor (e.g., a microprocessor, microcontroller, digital signal processor, or general purpose computer), programmable logic for use with a programmable logic device (PLD) (e.g., a Field Programmable Gate Array (FPGA) or other PLD), discrete components, integrated circuitry (e.g., an Application Specific Integrated Circuit (ASIC)), or any other means including any combination thereof. In a particular embodiment, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including, for example, programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method of arranging data in a directory, the directory being adapted to interface with disk storage, the method comprising:
arranging data of a directory in a format configured to enable the directory data to be memory mapped by an operating system, the data of the directory stored in computer-readable storage; and
associating a first portion of a non-persistent computer-readable memory with the data of the directory at least in part by calling a memory map function of the operating system, the memory map function returning a pointer corresponding to the first portion of the non-persistent computer-readable memory.

2. The method of claim 1, further comprising performing one or more directory operations using at least the associated first portion of the non-persistent computer-readable memory.

3. The method of claim 1, wherein the associating is performed in conjunction with one or more procedures selected from the group consisting of:
a startup procedure; and
a request response procedure.

4. The method of claim 1, further comprising:
deriving a plurality of indexes using at least the associated first portion of the non-persistent computer-readable memory; and
storing the derived plurality of indexes in a second portion of the non-persistent computer-readable memory.

5. The method of claim 4, wherein the first and second portions of the non-persistent computer-readable memory are contiguous with respect to each other.

6. The method of claim 4, wherein the first and second portions of the non-persistent computer-readable memory are fragmented with respect to each other.

7. The method of claim 1, wherein the format is further configured to support variable-length encoding.

8. The method of claim 1, wherein the format comprises one or more components selected from the group consisting of:
a value;
an identifier related to the value;
an entry identifier;
an attribute identifier;
size information;
a flag;
a mapping that maps an attribute identifier to information related to the attribute identifier, the information related to the attribute identifier comprising an attribute type name; and
a mapping that maps an object class identifier to information related to the object class identifier, the information related to the object class identifier comprising at least one of an object class name and an object identifier.

9. The method of claim 8, wherein the flag comprises one or more subcomponents selected from the group consisting of:
a fragment indicator;
an alias indicator;
an object class identifier;
a object class index; and
a naming attribute indicator.

10. The method of claim 8, wherein the identifier related to the value identifies that the value comprises one or more subcomponents selected from the group consisting of:
a parent identifier;
a distinguished name;
a password value; and
an aliased object name.

11. The method of claim 8, wherein the value represents an object class.

12. The method of claim 1, wherein the associated first portion of the non-persistent computer-readable memory represents substantially all of the data of the directory stored in the computer-readable storage.

13. The method of claim 1, further comprising performing a backup of the data of the directory stored in the computer-readable storage at least in part by generating a backup file using at least the first portion of the non-persistent computer-readable memory, the generated backup file stored in the computer-readable storage.

14. A directory information system comprising:
a computer-readable medium storing directory data comprising a format configured to enable the directory data to be memory mapped by an operating system; and
one or more processors operable to execute logic embodied in a persistent computer-readable memory, the logic embodied in the persistent computer-readable memory operable, when executed by the one or more processors, to associate a first portion of a non-persistent computer-readable memory with the data of the directory at least in part by calling a memory map function of the operating system, the memory map function returning a pointer corresponding to the first portion of the non-persistent computer-readable memory.

15. The directory information system of claim 14, wherein the logic is further operable to perform one or more directory operations using at least the associated first portion of the non-persistent computer-readable memory.

16. The directory information system of claim 14, wherein the logic is further operable to:
derive a plurality of indexes using at least the associated first portion of the non-persistent computer-readable memory; and
store the derived plurality of indexes in a second portion of the non-persistent computer-readable memory.

17. The directory information system of claim 14, wherein the format of the directory data is further configured to enable variable-length encoding.

18. The directory information system of claim 14, wherein the logic is further operable to perform a backup of the data of the directory stored in the computer-readable storage at least in part by generating a backup file using at least the first portion of the non-persistent computer-readable memory, the generated backup file stored in the computer-readable storage.

19. Logic embodied in a computer-readable memory and operable, when executed by one or more processors, to:
associate a first portion of a non-persistent computer-readable memory with data of a directory stored in persistent storage, the association executed at least in part by calling a memory map function of the operating system, the memory map function returning a pointer corresponding to the first portion of the non-persistent computer-readable memory; and
perform one or more directory operations using at least the synchronized first portion of the non-persistent computer-readable memory.

20. The logic of claim 19, wherein the logic is further operable to:
derive a plurality of indexes using at least the associated first portion of the non-persistent computer-readable memory; and
store the derived plurality of indexes in a second portion of the non-persistent computer-readable memory.

21. The logic of claim 19, wherein the directory data stored in the persistent computer-readable storage comprises a variable-length encoded format.
